(19) United States
(12) Patent Application Publication
(10) Pub. No.: US 2016/0010610 A1
(43) Pub. Date: Jan. 14, 2016

(54) FUEL INJECTION DEVICE

(71) Applicants: DENSO CORPORATION, Kariya-city (JP); KYUSHU UNIVERSITY, NATIONAL UNIVERSITY CORPORATION, Fukuoka-shi (JP)

(72) Inventors: Tomoki FUJINO, Okazaki-city (JP); Shinichiro KAWAKITA, Obu-city (JP); Wakichi KONDOH, Nagoya-city (JP); Yoshiaki NISHIJIMA, Toyokawa-city (JP); Hiroshi TAJIMA, Fukuoka-city (JP)

(21) Appl. No.: 14/792,971

(22) Filed: Jul. 7, 2015

(30) Foreign Application Priority Data
Jul. 11, 2014 (JP) 2014-143154

(51) Int. Cl. F02M 61/10; F02M 61/16; F02B 9/02; F02M 63/00

(52) U.S. Cl. CPC F02M 61/10; F02M 63/0077; F02M 61/168; F02B 9/02

(57) ABSTRACT

A fuel injection device injects natural gas from a first injection hole of a first housing and injects light oil form a second injection hole of a second housing. A weld part as a fixation part fixes positions of the first injection hole and the second injection hole such that a spray of natural gas injected from the first injection hole and a spray of light oil injected from the second injection hole contact each other. Thus the spray of light oil self-ignites by compression of air in a cylinder of an internal combustion engine and the spray of natural gas burns by ignition from a flame of the self-ignited light oil.

### CROSS REFERENCE TO RELATED APPLICATION

This application is based on Japanese patent application No. 2014-143154 filed on Jul. 11, 2014, the contents of which are incorporated herein by reference.

### FIELD

The present disclosure relates to a fuel injection device.

### BACKGROUND

A fuel injection device conventionally injects fuel into a cylinder of an internal combustion engine. A fuel injection device disclosed in U.S. Pat. No. 6,439,192 is provided with pilot injection holes at an end part exposed in a cylinder and gaseous fuel injection holes at a more solenoid side than the pilot injection holes. The fuel injection device injects liquid fuel from the pilot injection holes and gaseous fuel from the gaseous fuel injection holes. In the fuel injection device, the pilot injection holes and the gaseous fuel injection holes are relatively rotatable in a circumferential direction and the numbers of the pilot injection holes and the gaseous fuel injection holes are different from each other. The fuel injection device is thus configured to provide an area, in which a distance between a spray of fuel (referred to as a pilot spray below) injected from any one of plural pilot injection holes and a spray of fuel (referred to as a gaseous fuel spray below) injected from any one of plural gaseous fuel injection holes become short when the pilot injection holes and the gaseous fuel injection holes relatively rotate in the circumferential direction.

The fuel injection device described above, however, also provides an area, in which a distance between the pilot spray and the gaseous fuel spray becomes long in addition to the area of the short distance when the pilot injection holes and the gaseous fuel injection holes relatively rotate in the circumferential direction. Further, in this fuel injection device, the areas of short distance and the long distance between the pilot injection spray and the gaseous fuel spray vary because of the relative rotation between the pilot injection holes and the gaseous fuel injection holes. For this reason, combustion of the gaseous fuel spray is likely to worsen in the area, in which the distance between the pilot spray and the gaseous fuel spray is long. Further, since the areas of the short distance and the long distance between the pilot spray and the gaseous fuel spray vary, the combustion in the cylinder varies and becomes unstable. As a result, torque variation of the internal combustion engine becomes large and exhaust emission of hydrocarbon (HC) and carbon monoxide (CO) and the like emitted from the internal combustion engine increases.

### SUMMARY

It is therefore has an object to provide a fuel injection device, which provides stable combustion in an internal combustion engine.

According to one aspect, a fuel injection device comprises a first housing, a first needle valve, a second housing, a second needle valve and a fixation part. The first housing includes a first injection hole for injecting first fuel, a first fuel passage communicated with the first injection hole and a first valve seat formed on an inner wall of the first fuel passage. The first needle valve is housed inside the first housing to be reciprocally movable in an axial direction of the first housing for opening and closing the first injection hole by separating from and seating on the first valve seat. The second housing includes a second injection hole for injecting second fuel of a cetane number different from that of the first fuel, a second fuel passage communicated with the second injection hole, and a second seat formed in the second fuel passage. The second needle valve is housed inside the second housing to be reciprocally movable in an axial direction of the second housing for opening and closing the first injection hole by separating from and seating on the second valve seat. The fixation part fixes positions of the first injection hole and the second injection hole such that a spray of the first fuel injected from the first injection hole and a spray of the second fuel injected from the second injection hole contact each other.

### BRIEF DESCRIPTION OF THE DRAWINGS

FIG. 1 is a sectional view of a fuel injection device according to a first embodiment;

FIG. 2 is an enlarged view of a part indicated with II in FIG. 1;

FIG. 3 is an outside view of a part II shown in FIG. 1;

FIG. 4 is a bottom view of a part viewed in a direction indicated with IV in FIG. 3;

FIG. 5 is a schematic view showing directions of fuel sprays;

FIG. 6A to FIG. 6C are characteristic graphs, each showing a relation between a spray direction and a heat generation rate;

FIG. 7A to FIG. 7C are characteristic graphs, each showing a relation between a spray direction and a heat generation rate;

FIG. 8 is a characteristic graph showing a relation between a spray direction and an exhaust emission quantity;

FIG. 9 is a sectional view of a fuel injection device according to a second embodiment;

FIG. 10 is a sectional view of a fuel injection device according to a third embodiment;

FIG. 11 is a sectional view of a main part taken along a line XI-XI indicated in FIG. 10;

FIG. 12 is a schematic view showing a state of two fuel injection devices of a reference example 1 in an internal combustion engine;

FIG. 13 is a characteristic graph showing a relation between a spray direction and a heat generation rate according to the reference example 1;

FIG. 14 is a schematic view showing a state of two fuel injection devices of a reference example 2 in an internal combustion engine; and

FIG. 15 is a characteristic graph showing a relation between a spray direction and a heat generation rate according to the reference example 2.

### EMBODIMENT

A fuel injection device will be described in detail with reference to plural embodiments shown in the drawings.

### First Embodiment

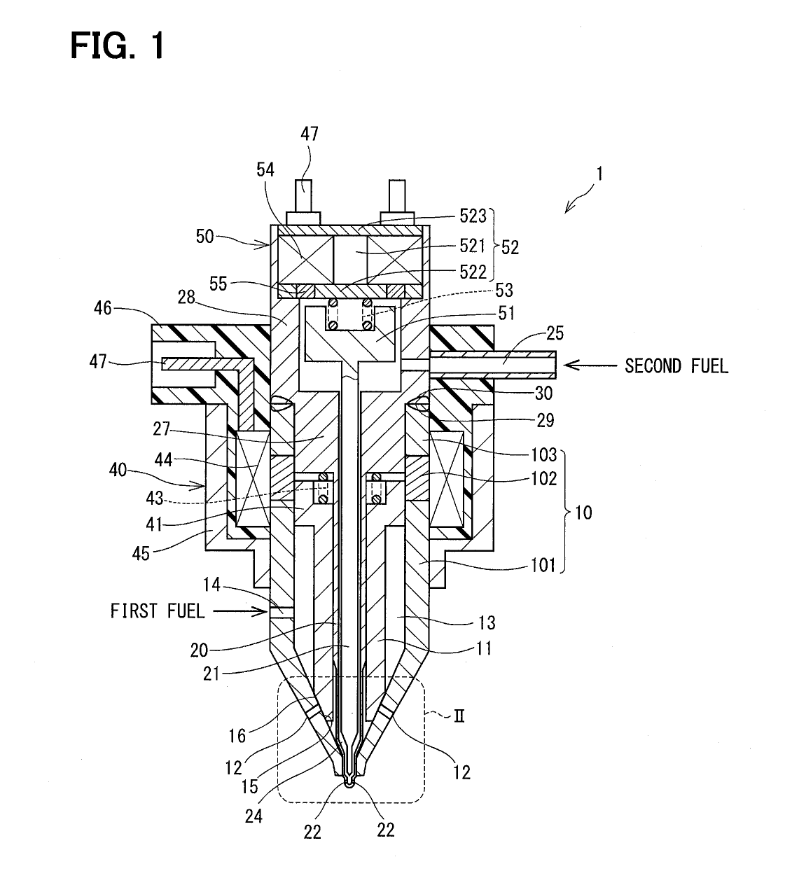

Referring first to FIG. 1 showing a first embodiment, a fuel injection device 1 is configured to inject two kinds of fuels having different cetane numbers directly into each cylinder of an internal combustion engine. In the first embodiment, the fuel injection device 1 is assumed to inject two kinds fuels, one of which is light oil as high cetane fuel, that is, fuel of high cetane number, and the other of which is natural gas as low cetane fuel, that is, fuel of low cetane number.

As shown in FIG. 1 and FIG. 2, the fuel injection device 1 includes a first housing 10, a first needle valve 11, a second housing 20, a second needle valve 21, a weld part 30 as a fixation part, a first driving part 40, a second driving part 50 and the like. The first housing 10 is formed in a cylindrical shape and provided with plural first injection holes 12 in a part, which is to be exposed in the cylinder of the internal combustion engine. The first housing 10 has a first magnetic part 101, a non-magnetic part 102 and a second magnetic part 103 from the first injection hole 12 side. The non-magnetic part 102 is sandwiched between the first magnetic part 101 and the third magnetic part 103 to prevent magnetic short-circuiting between the first magnetic part 101 and the second magnetic part 103. The first magnetic part 101, the non-magnetic part 102 and the second magnetic part 103 are fixed one another by welding.

The first housing 10 has a first fuel passage 13 in its inside. The first fuel passage 13 is supplied with natural gas as first fuel from a first fuel supply passage 14 provided in the first housing 10. A first valve seat 15 is formed in a reverse taper shape on an inner wall of the first fuel passage 13. The first needle valve 11 is formed in a cylindrical shape and housed inside the first housing 10 to be reciprocally movable in an axial direction (up-down direction in FIG. 1). A first valve head 16 in a taper shape is formed at an end part of the first injection hole 12 side of the first needle valve 11. The first needle valve 11 closes the plural first injection holes 12 when the first valve head 16 seats on the first valve seat 16 and opens the plural first injection holes 12 when the first valve head 16 leaves from the first valve seat 15.

The second housing 20 is formed in a cylindrical shape and provided in a radially inside the first needle valve 11. As shown in FIG. 2, one axial end part of the second housing 20 is exposed from a hole 18 provided at a radial center of an axial end part of the first housing 10. The second housing 20 has a taper surface 23 on its outer wall, which is opposite to the second injection hole 22 in the axial direction than a central hole 18 formed in the radial center of the axial end part of the first housing 10 to extend in the axial direction. The first housing 10 has a reverse taper surface 17 on its inner wall at a position corresponding to the taper surface 23. The taper surface 23 of the second housing 20 and the reverse taper surface 17 of the first housing 10 fit air-tightly or fluid-tightly to provide a metal seal therebetween. This metal seat prevents fuel leak from the first fuel passage 13.

The second housing 20 has plural second injection holes 22 at an axial end part exposed from the central hole 18 of the first housing 10. The second housing 20 has a second fuel passage 24 in its inside part. The second fuel passage 24 is supplied with the light oil as second fuel from a second fuel supply passage 25 provided in the second housing 20. A second valve seat 26 is formed in a reverse taper shape on an inside wall of the second fuel passage 24. The second needle valve 21 is housed inside the second housing 20 to be reciprocally movable in the axial direction. At an axial end part of the second injection hole 22 side of the second needle valve 21, a second valve head 211 is formed in a taper shape. The second needle valve 21 closes the plural second injection holes 22 when the second valve head 211 seats on the second valve seat 26 and opens the plural second injection holes 22 when the second valve head 211 leaves the second valve seat 26.

As shown in FIG. 1, the second housing 20 is provided with a first fixed core part 27, which is enlarged to have a large thickness in a radial direction, at its axial end part opposite to the second injection hole 22 side in the axial direction. The first fixed core part 27 is positioned to be more distanced from the injection hole 12 than the first needle valve 11 is. A large-diameter cylindrical part 28 is provided at a first fixed core part 27 side, which is opposite to the second injection hole 22 in the axial direction. The cylindrical part 28 has an outer diameter larger than that of the first fixed core part 27. Thus a step 29 is provided between the first fixed core part 27 and the large-diameter cylindrical part 28. This step 29 contacts an axial end surface of the first housing 10 at a side opposite to the first injection hole 12. The step 29 of the second housing 20 and the end surface of the first housing 10, which is opposite to the first injection hole 12 side, are fixed each other by welding. In FIG. 1, this weld part is schematically indicated with a reference numeral 30. The weld part 30 restricts the first housing 10 and the second housing 20 from rotating relatively in a circumferential direction. Thus positions of the plural first injection holes 12 provided in the first housing 10 and positions of the plural second injection holes 22 provided in the second housing 20 are fixed. The weld part 30 is one example of a fixation part.

The first driving part 40 and the second driving part 50 in the first embodiment are both electromagnetically operated. The first driving part 40 is configured to drive the first needle valve 11. The first driving part 40 is formed of a first movable core part 41, a first fixed core part 27, a first spring 43, a first coil 44 and the like. The first movable core part 41 is a magnetic body and formed integrally with the first needle valve 11 at a side axially opposite to the first valve head 16 of the first needle valve 11. The first movable core 41 is slidable relative to the inner wall of the first housing 10. The first fixed core part 27 is also a magnetic body and formed integrally with the second housing 20 at a side more opposite to the injection hole 22 in the axial direction than the first movable core part 41 is. The first spring 43 is provided between the first movable core part 41 and the first fixed core par 27 to bias the first movable core part 41 toward the first injection hole 12 side. The first housing 10 includes the non-magnetic part 102, which is provided radially outside a magnetic gap formed between the first movable core part 41 and the first fixed core part 27. A first coil 44 is wound about a radially outside part of the first housing 10. A yoke 45 is provided outside the first coil 44.

When a current is supplied from terminals 47 of a connector 46 provided outside the first housing 10, the first coil 44 generates a magnetic field so that magnetic flux flows in a magnetic circuit, which is formed of the first fixed core part 27, the first movable core part 41, the first magnetic part 101, the yoke 45, the second magnetic part 103 and the like. As a result, a magnetic attraction force is generated between the first movable core part 41 and the first fixed core part 27 so that the first movable core part 41 is magnetically attracted to the first fixed core part 27 side, that is, the first movable core part 41 is lifted against the spring 43. At this time, the first valve head 16 of the first needle valve 11 leaves the first valve seat 15 thereby to inject natural gas from the plural first injection holes 12. When the current supply to the first coil 44 is stopped, the magnetic attraction force between the first movable core part 41 and the first fixed core part 27 disappear so that the first movable core part 41 is moved back toward the first injection hole 12 side by the biasing force of the first spring 43. Thus the first valve head 16 of the first needle valve 11 seats on the first valve seat 15 thereby to stop fuel injection from the plural first injection holes 12.

The second driving part 50 is configured to drive the second needle valve 21. The second driving part 50 is formed of a second movable core part 51, a second fixed core part 52, a second spring 53, a second coil 54 and the like. The second movable core part 51 is a magnetic body and formed integrally with the second needle valve 21 at a side opposite to the valve head 211 of the second needle valve 21 in the axial direction. The second movable core part 51 is slidable relative to the inner wall of the large-diameter cylindrical part 38. The second fixed core part 52 is also a magnetic body and provided at a side more opposite to second injection hole 22 than the second movable core part 51 is in the axial direction. The second fixed core part 52 is fixed to the large-diameter cylindrical part 28. The second fixed core part 52 is formed of a shaft part 521 provided in a radial center of the second coil 54, a lower disk part 522 provided at the second movable core part 51 side of the shaft part 521 and an upper disk part 523 provided at a side axially opposite to the second movable core part 521 of the shaft part 521. A second non-magnetic part 55 formed in an annular shape is provided radially outside the lower disk part 522. The second non-magnetic part 55 prevents the lower disk part 522 and the large-diameter cylindrical part 28 from magnetically short-circuiting. A second spring 53 is provided between the second movable core part 51 and the second fixed core part 52 to bias the second movable core part 51 toward the second injection hole 22 side.

When a current is supplied from second terminals 47 provided outside the upper disk part to the second coil 54, the second coil 54 generates a magnetic field so that magnetic flux flows in a magnetic circuit formed of the second fixed core part 52, the second movable core part 51, the large-diameter cylindrical part 28 and the like. As a result, a magnetic attraction force is generated between the second movable core part 51 and the second fixed core part 27 so that the second movable core part 51 is magnetically attracted to the second fixed core part 27 side. At this time, the valve head 211 of the second needle valve 21 leaves the second valve seat 26 thereby to inject light oil from the plural second injection holes 22. When the current supply to the second coil 54 is stopped, the magnetic attraction force between the second movable core part 51 and the second fixed core part 52 disappears so that the second movable core part 51 is moved to the second injection holes 22 side by the biasing force of the second spring 53. Thus the valve head 211 of the second needle valve 21 seats on the second valve seat 26 thereby to stop fuel injection from the plural second injection holes 22.

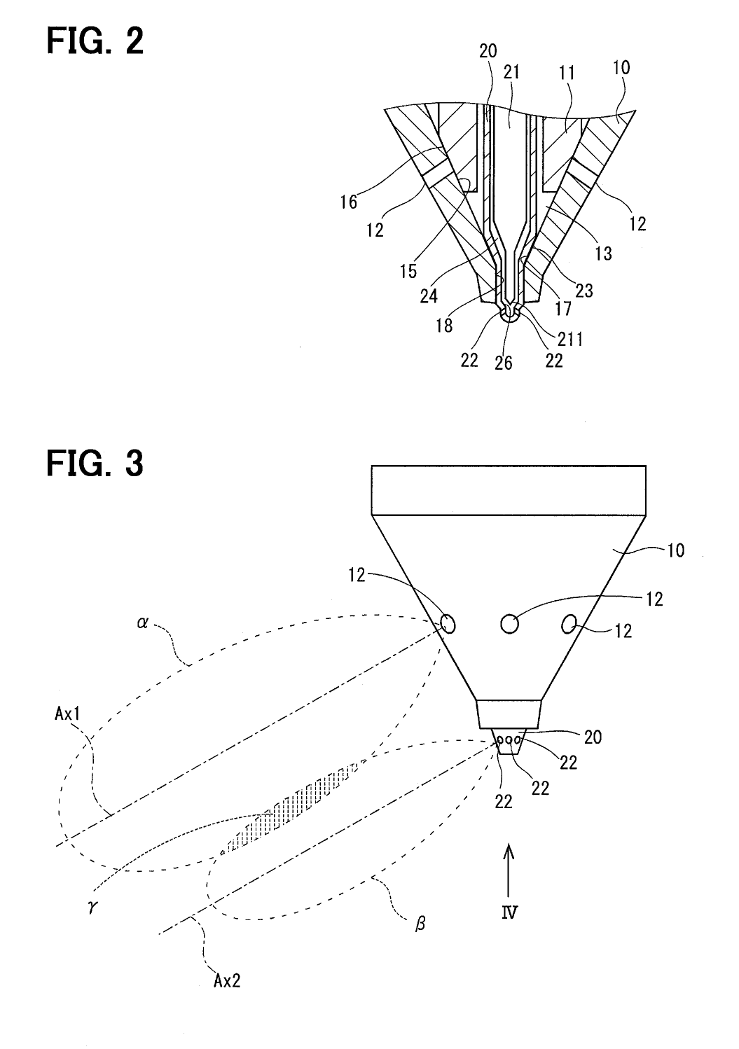

The positional relation between the plural first injection holes 12 and the plural second injection holes 22 will be described next with reference to FIG. 3 to FIG. 5. In FIG. 3, a central axis of the first injection hole 12, which is one of the plural first injection holes 12, is indicated with a one-dot chain line Ax1 and a fuel spray formed of fuel injected from the first injection hole 12 is indicated schematically with a dotted line α. Similarly, a central axis of the second injection hole 22, which is one of the plural second injection holes 12, is indicated with a one-dot chain line Ax2 and a fuel spray formed of fuel injected from the second injection hole 22 is indicated schematically with a dotted line 13.

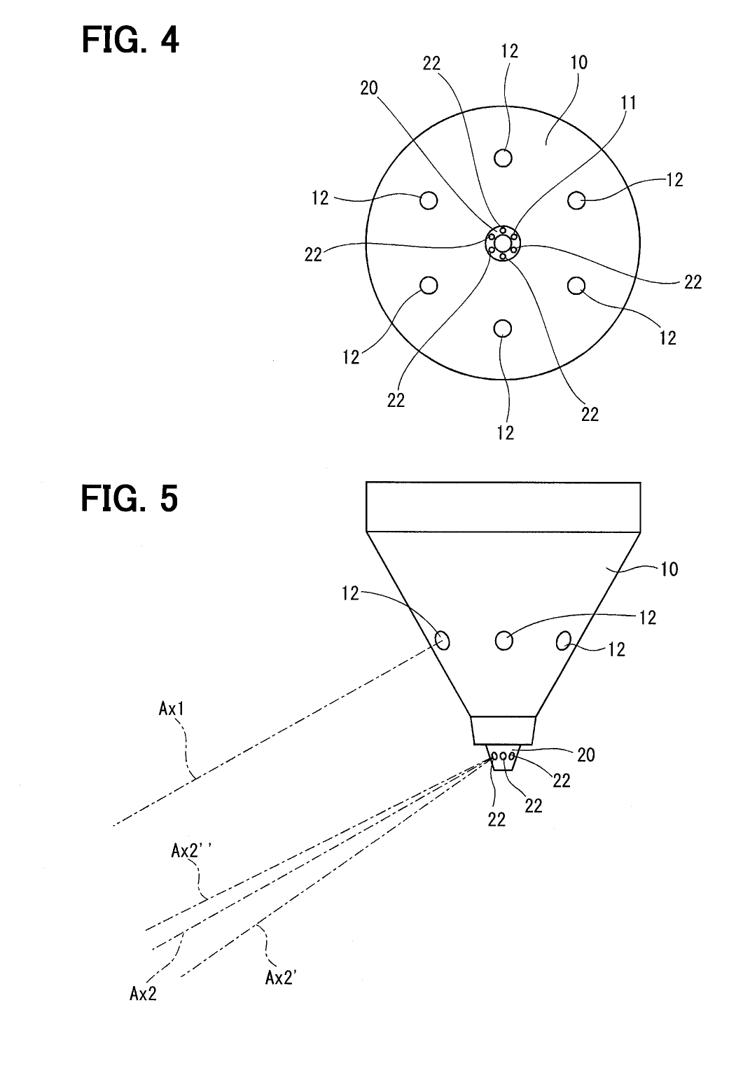

As shown in FIG. 3 and FIG. 4, the number of the plural first injection holes 12 and the number of the plural second injection holes 22 are equal to each other, for example, six. Both of the plural first injections holes 12 and the plural second injection holes 22 are provided equi-angularly in the circumferential direction. The plural first injection holes 12 and the plural second injection holes 22 are spaced away from each other in the axial direction and the radial direction of the first housing 10. That is, the first injection hole 12 and the second injection hole 22 are located at the same circumferential position without being displaced angularly in the circumferential direction.

In FIG. 3, the central axis Ax1 of the first injection hole 12 and the central axis Ax2 of the second injection hole 22, which is arranged in parallel with and spaced away in the axial direction and the radial direction from the first injection hole 12, extend in parallel. All central axes Ax1 of the first injection holes 12 and all central axes Ax2 of the second injection holes 22 are arranged to be in parallel, respectively. In FIG. 3, an area γ of overlapping of the fuel spray α formed by injection from the first injection hole 12 and the fuel spray β formed by injection from the second injection hole 22 is indicated with slash lines. All fuel sprays α formed by injections from the first injection holes 12 and all fuel sprays β formed by injections from the second injection holes 22, which are arranged in parallel with and spaced away in the axial direction and the radial direction from the first injection holes 12, contact each other, respectively.

As shown in FIG. 5, the central axes Ax1 of the plural first injection holes 12 and the central axes Ax2 of the plural second injection holes 22 form an angle, which the fuel injection device 1 adopts in the first embodiment. In the following description, this angle formed by the central axis Ax1 of the first injection hole 12 and the central axis Ax2 of the second injection hole 22 is referred to as a fuel spray direction. In the first embodiment, as indicated by the one-dot chain lines Ax1 and Ax2, the central axes of the plural first injection holes 12 and the central axes of the plural second injection holes 22 are all set to be in parallel, respectively. Alternatively, as indicated by one-dot chain lines Ax1 and Ax2′, the central axes of the plural first injection holes 12 and the central axes of the plural second injection holes 22 may be set such that the central axes Ax1 and Ax2′ become farther as the central axes extend from the injection holes 12 and 22, respectively. That is, the central axes Ax1 and Ax2′ are set to be separated gradually in proportion to a distance from the injection holes 12 and 22. Further alternatively, as indicated by one-dot chain lines Ax1 and Ax2″, the central axes of the plural first injection holes 12 and the central axes of the plural second injection holes 22 may be set such that the central axes Ax1 and Ax2″ become closer to each other as the central axes extend from the injection holes 12 and 22, respectively. That is, the central axes Ax1 and Ax2″ are set to approach gradually in proportion to a distance from the injection holes 12 and 22. The central axis Ax1 of the first injection hole 12 for the fuel spray and the central axis Ax2 of the second injection hole 22 for the fuel spray are set to reduce quantity of exhaust emission from the internal combustion engine as much as possible.

In the first embodiment, a parallel state of the central axis Ax1 of the first injection hole 12 and the central axis Ax2 of the second injection hole 22 as indicated by the one-dot chain lines in FIG. 5 is assumed that the fuel spray direction is 0°, which is a reference angle. Further, another state of gradual separation of the central axis Ax1 of the first injection hole 12 and the central axis Ax2′ of the second injection hole 22 in proportion to a distance from the injection holes 12 and 22 as indicated by the one-dot chain lines in FIG. 5 is assumed that the fuel spray direction has a positive angle larger than 0°. Still further, the other state of gradual approach of the central axis Ax1 of the first injection hole 12 and the central axis Ax2″ of the second injection hole 22 in proportion to a distance from the injection holes 12 and 22 as indicated by the one-dot chain lines in FIG. 5 is assumed that the fuel spray direction has a negative angle smaller than 0°.

In FIG. 5, the central axis Ax1 of the first injection hole 12 is fixed and the central axis Ax2 of the second injection hole 22 is varied. Alternatively, the central axis Ax1 may be varied and the central axis Ax2 of the second injection hole 22 may be fixed. Further alternatively, both of the central axis Ax1 of the first injection hole 12 and the central axis Ax2 of the second injection hole 22 may be varied. In varying the central axis Ax1 of the first injection hole 12 and/or the central axis Ax2 of the second injection hole 12, the central axes Ax1 and/or Ax2 may be varied in the circumferential direction of the first housing 10 in place of the axial direction of the first housing 10, which is shown in FIG. 5.

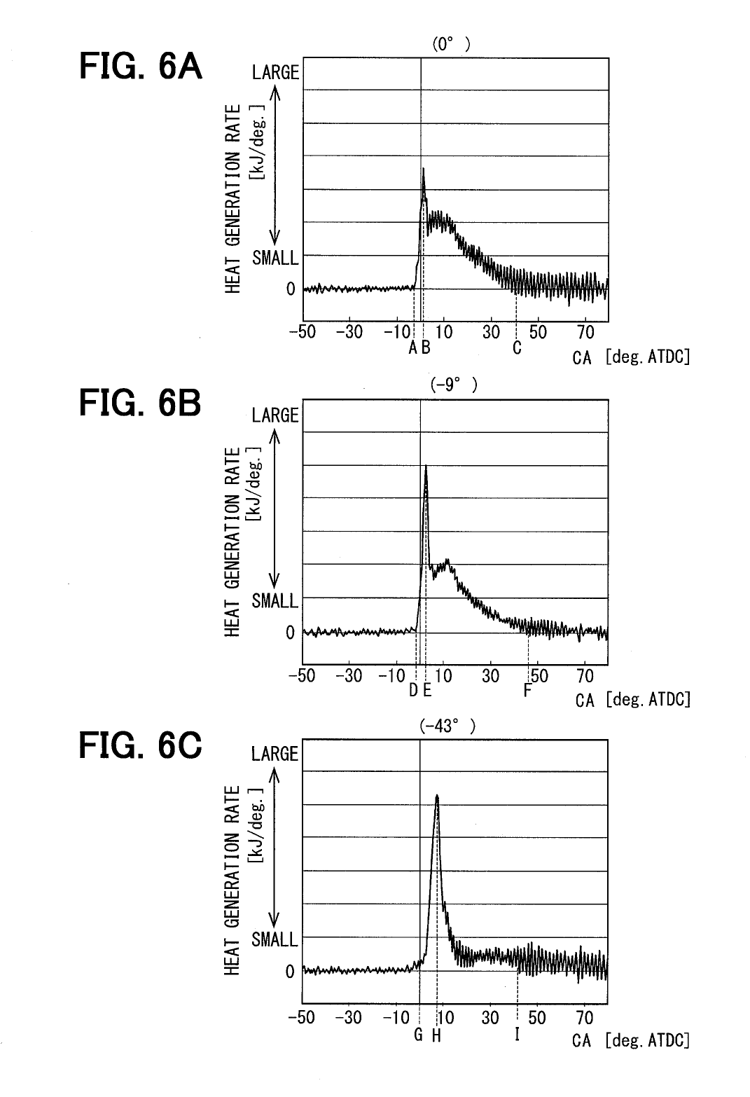

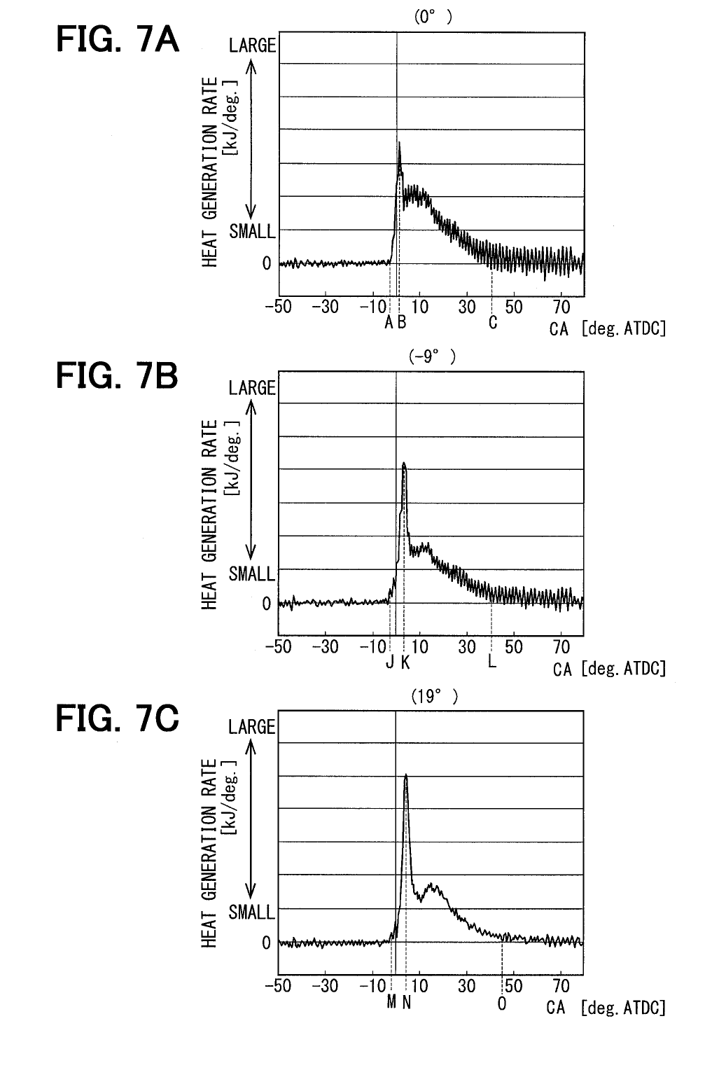

A relation of a heat generation rate and an exhaust emission quantity of the internal combustion engine relative to a variation in the fuel spray direction will be described with reference to experimental results shown in FIG. 6A to FIG. 6C and FIG. 7A to FIG. 7C. The experimental results of FIG. 6A to FIG. 6C and FIG. 7A to FIG. 7C are produced by performing fuel injections from the plural first injection holes 12 and fuel injections from the plural second injection holes 22 simultaneously. FIG. 6A shows the heat generation rate of the internal combustion engine when the fuel spray direction is 0°, that is, when the central axis Ax1 of the first injection hole 12 and the central axis Ax2 of the second injection hole 22 are parallel. FIG. 6A shows that the fuel spray of light oil ignited at a crank angle A degrees (° CA after top dead center) and the resulting flame ignited the spray of the natural gas for combustion. The heat generation rate became a maximum at a crank angle B degrees and the combustion ended near a crank angle C degrees. In the graphs of FIG. 6A to FIG. 6C and FIG. 7A to FIG. 7C, an integrated value of heat generation rate from the ignition of the fuel spray of the light oil to the end of the combustion of the light oil and the natural gas is considered to correspond to a combustion quantity of fuel.

FIG. 6B shows the heat generation rate of the internal combustion engine when the fuel spray direction is −9°, that is, when the central axis Ax1 of the first injection hole 12 and the central axis Ax2 of the second injection hole 22 are set to approach closer in proportion to a distance from the injection holes 12 and 22. FIG. 6B shows that the fuel spray of light oil ignited at a crank angle D degrees and the resulting flame ignited the spray of the natural gas for combustion. The heat generation rate became a maximum at a crank angle E degrees and the combustion ended near a crank angle F degrees. The crank angle D degrees in FIG. 6B, which is an ignition timing of the fuel spray, is delayed slightly from the crank angle A degrees shown in FIG. 6A.

FIG. 6C shows the heat generation rate of the internal combustion engine when the fuel spray direction is −43°, that is, when the central axis Ax1 of the first injection hole 12 and the central axis Ax2 of the second injection hole 22 are set to approach much closer in proportion to a distance from the injection holes 12 and 22 than in the case of FIG. 6B. FIG. 6C shows that the fuel spray of light oil ignited at a crank angle G degrees and the resulting flame ignited the spray of the natural gas for combustion. The heat generation rate became a maximum at a crank angle H degrees and the combustion ended near a crank angle I degrees. The crank angle G degrees in FIG. 6C, which is an ignition timing of the fuel spray, is delayed from the crank angle A degrees shown in FIG. 6A more than the delay shown in FIG. 6B. The combustion quantity of fuel shown in FIG. 6C is considered to be smaller than that shown in FIG. 6A.

From the experimental results shown in FIG. 6A to FIG. 6C, it is understood that the ignition timing of the fuel spray is delayed as the central axis Ax1 of the first injection hole 12 and the central axis Ax2 of the second injection hole 22 become closer in proportion to a distance from the first injection hole 12 and the second injection hole 22. This is considered to arise because, when the fuel spray of light oil and the fuel spray of the natural gas interfere, that is, when the spray direction is more negative, air is not easily introduced into the fuel spray of light oil and a delay of ignition from the injection of light oil to self-ignition thereof becomes longer. It is also understood that the combustion quantity of fuel decreases as the ignition timing delays. This is considered to arise because, when the delay of ignition of the light oil becomes longer, air is introduced into the natural gas and pre-mixed before the ignition after the injection of natural gas. As a result, the fuel spray of natural gas is rarefied to be lean and less combustible.

FIG. 7A shows the same experimental result as that shown in FIG. 6A and hence no further description is made. FIG. 7B shows the heat generation rate of the internal combustion engine when the fuel spray direction is 9°, that is, when the central axis Ax1 of the first injection hole 12 and the central axis Ax2 of the second injection hole 22 are set to separate more in proportion to the distance from the injection holes 12 and 22. FIG. 7B shows that the fuel spray of light oil ignited at a crank angle J degrees and the resulting flame ignites the spray of the natural gas for combustion. The heat generation rate became a maximum at a crank angle K degrees and the combustion ended near a crank angle L degrees. The crank angle J degrees in FIG. 7B, which is an ignition timing of the fuel spray, is almost the same as the crank angle A degrees shown in FIG. 7A.

FIG. 7C shows the heat generation rate of the internal combustion engine when the fuel spray direction is 19°, that is, when the central axis Ax1 of the first injection hole 12 and the central axis Ax2 of the second injection hole 22 are set to separate much more in proportion to the distance from the injection holes 12 and 22 than in the case of FIG. 7B. FIG. 7C shows that the fuel spray of light oil ignited at a crank angle M degrees and the resulting flame ignited the spray of the natural gas for combustion. The heat generation rate became a maximum at a crank angle N degrees and the combustion ended near a crank angle O degrees. The crank angle M degrees in FIG. 7C, which is an ignition timing of the fuel spray, is delayed from the crank angle A degrees shown in FIG. 7A.

From the experimental results shown in FIG. 7A to FIG. 7C, it is understood that the ignition timing of the fuel spray is almost the same as the central axis Ax1 of the first injection hole 12 and the central axis Ax2 of the second injection hole 22 separates more in proportion to the distance from the first injection hole 12 and the second injection hole 22. It is further understood that the combustion quantity of fuel also is almost the same. It is thus understood that, unless the fuel spray of light oil and the fuel spray of natural gas interfere largely, air is easily introduced into the fuel spray of light oil and hence a delay of ignition does not substantially change. This is considered to arise because, when the delay of ignition of the light oil spray does not substantially change, the quantity of air is introduced into the fuel spray before the ignition after the injection of natural gas. As a result, the fuel spray of natural gas does not become lean and remains highly combustible.

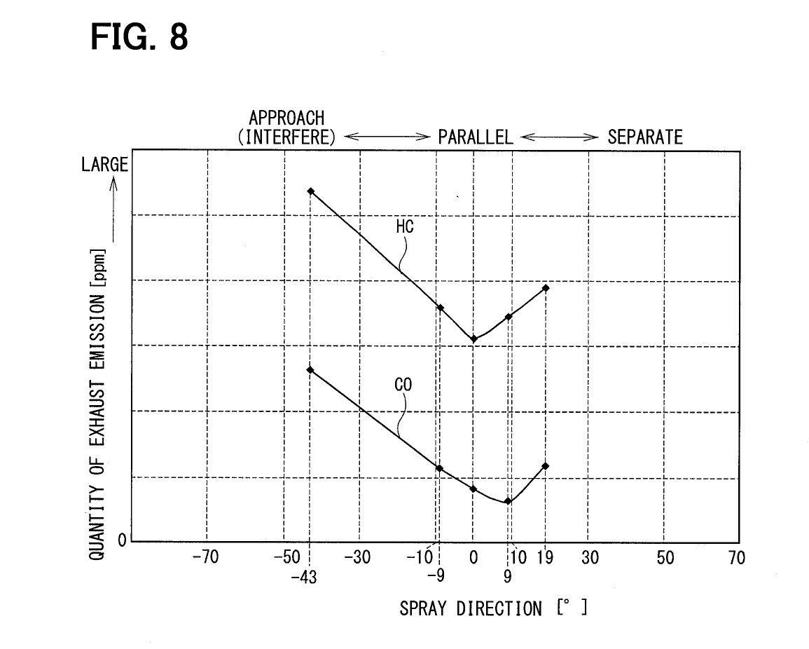

FIG. 8 shows a relation between a fuel spray direction and quantities of exhaust emissions, which are noxious. Among noxious exhaust emissions, the quantity of hydrocarbon emission (HC) became the smallest when the fuel spray direction was 0°. The quantity of hydrocarbon emission increased as the fuel spray direction was changed from 0° toward the negative side (that is, fuel sprays became closer to each other from the parallel relation). The quantity of hydrocarbon emission increased as the fuel spray direction was changed from 0° toward the positive side (that is, fuel sprays became separated from the parallel relation). The rate of increase of hydrocarbon emission was larger when the fuel spray direction changed from 0° to the negative side than when the fuel spray direction changed from 0° to the positive side.

Among exhaust emissions, the quantity of carbon monoxide (CO) emission became the smallest when the fuel spray direction was 9°. The emission quantity of carbon monoxide increased as the fuel spray direction was changed from 9° toward the negative side. The quantity of carbon monoxide emission increased as the fuel spray direction was changed from 9° toward the positive side. The emission quantity of carbon monoxide when the fuel spray direction was 19° was approximately the same quantity of carbon monoxide when the fuel spray direction was −9°. From the results shown in FIG. 8, it is understood that the fuel injection device 1 can reduce the quantity of exhaust emission by setting the fuel spray direction between −9° and 19°. However, in the fuel injection device 1 according to the first embodiment, the fuel spray direction is not limited to a range, which is between −9° to 19°. Alternatively, it may be set differently through experiments based on various conditions, which may be the distance between the first injection hole 12 and the second injection hole 22, magnitudes of dispersions of fuel sprays corresponding to shapes of the first injection hole 12 and the second injection hole 22, fuel pressure, injection timing and the like.

The fuel injection device 1 according to the first embodiment provides the following operations and advantages.

(1) The fuel injection device 1 has the first injection hole 12 and the second injection hole 22 at the fixed positions so that the fuel spray of the light oil and the fuel spray of the natural gas contact each other. Thus, the fuel spray of the light oil self-ignites through compression of air in the cylinder of the internal combustion engine and the fuel spray of the natural gas is ignited to burn by the flame of the self-ignited light oil. The fuel injection device 1 therefore can provide stable combustion of the fuel sprays of light oil and natural gas. As a result, the fuel injection device 1 can reduce torque variation of the internal combustion engine and reduce exhaust emissions from the internal combustion engine.

(2) The fuel injection device 1 is provided with the second housing 20 at a radially inside part of the first needle valve 11, which is formed cylindrically. The weld part 30 as the fixation part restricts the relative rotation of the first housing 10 and the second housing 20 in the circumferential direction. The weld part 30 thus can fix the first injection hole 12 and the second injection hole 22 with simple configuration.

(3) The fuel sprays of natural gas injected from the plural first injection holes 12 can contact the fuel sprays of light oil injected from the plural second injection holes 22, respectively. It is thus possible to prevent formation of areas, where fuel cannot be burned well. For this reason, the natural gas injected from the plural first injection holes 12 can be burned satisfactorily.

(4) The number of the plural first injection holes 12 and the number of the plural second injection holes 22 are equal. It is thus possible to correspond all of the fuel sprays of the natural gas injected from the plural first injection holes 12 to the fuel sprays of the light oil, respectively. As a result, it is possible to contact the flame of the self-ignited light oil to the corresponding fuel spray of natural gas injected from the plural first injection holes 12.

(5) The first injection hole 12 and the second injection hole 22 are arranged in the axial direction of the first housing 10 and is overlapped in the circumferential direction. That is, the first injection hole 12 and the second injection hole 22 are spaced apart in the axial and radial directions of the housings 10 and 20 and is located at the same angular position in the circumferential direction of the housings 10 and 20. It is thus possible to provide the first injection hole 12 and the second injection hole 22 closely. As a result, the fuel spray of the light oil and the fuel spray of the natural gas can be easily contacted.

(6) The central axis Ax1 of the first injection hole 12 and the central axis Ax2 of the second injection hole 22 are arranged in parallel or arranged to be more separated as the central axes Ax1 and Ax2 extend from the first injection holes 12 and the second injections holes 22. With this arrangement, the fuel spray of the light oil and the fuel spray of the natural gas are suppressed from interfering each other and hence air can be introduced well into the fuel spray of light oil, which ignites first. For this reason, the fuel spray of light oil can ignite itself in a short time delay from the injection to the self-ignition. Since the quantity of air introduced into the fuel spray of natural gas from the injection of natural gas to the ignition is small, the fuel spray of natural gas can be suppressed from being rarefied. As a result, since the natural gas can burn well, the exhaust emission from the internal combustion engine can be reduced.

(7) The central axis Ax1 of the first injection hole 12 and the central axis Ax2 of the second injection hole 22 are arranged in parallel or arranged to approach more as the central axes Ax1 and Ax2 extend from the first injection holes 12 and the second injections holes 22 to the extent that the quantity of noxious exhaust emission from the internal combustion engine is permissible. Here, the permissible quantity of the exhaust emission from the internal combustion engine means the generally same quantity of the exhaust emission, which is outputted in a case that the central axis Ax1 of the first injection hole 12 and the central axis Ax2 of the second injection hole 22 are arranged to be more separated as the axes Ax1 and Ax2 extend from the injection holes 12 and 22. That is, even when the first central axis Ax1 of the first injection hole 12 and the central axis Ax2 of the second injection hole 22 are arranged to approach each other as the axes Ax1 and Ax2 extend from the injection holes 12 and 22, it is possible to restrict the fuel spray of light oil and the fuel spray of natural gas from interfering each other largely as far as the angle of approaching is small. As a result, the exhaust emission of the internal combustion engine can be reduced.

(8) The direction of fuel spray is set to be between −9° to 19°, for example. When the directions of fuel sprays are directed to be more negative side than −9°, the interference between the fuel spray of light oil and the fuel spray of natural gas increases and the exhaust emission increases. On the other hand, when the directions of fuel sprays are directed to be more positive side than 19°, the flame of light oil tends to fail to ignite the fuel spray of natural gas and the exhaust emission increases. For this reason, limiting the directions of fuel injections in a range from −9° to 19° is advantageous to reduce the exhaust emission.

(9) In the fuel injection device 1, the first housing 10 and the second housing 20 are fixed at the weld part 30, which is at the opposite side to the first needle valve 11, thereby to prevent the first housing 10 and the second housing 20 from relatively rotating in the circumferential direction. The first housing 10 and the second housing 20 can thus be fixed in the simple configuration. Since the weld part 30 is located at a side more opposite to the injection hole than the first needle valve 11 is, the first housing 10 can be surely welded to the thick part of the second housing 20.

### Second Embodiment

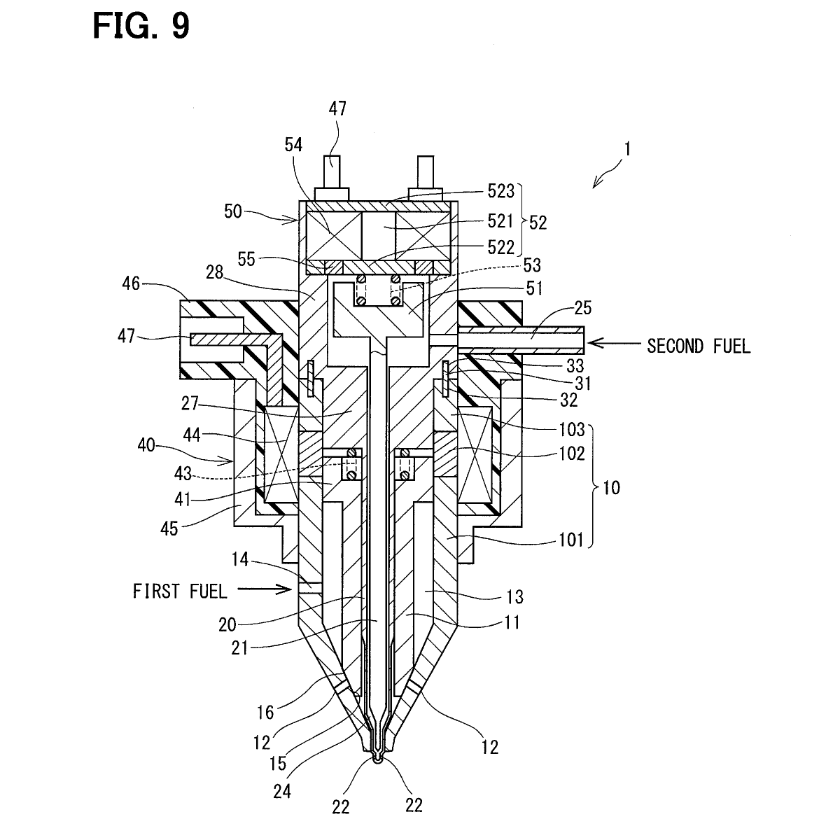

A second embodiment of a fuel injection device is shown in FIG. 9. In the following plural embodiments, same structural parts as the first embodiment are designated with the same reference numerals thereby to simplify the description. The fuel injection device 1 according to the second embodiment uses plural positioning pins 31 as the fixation part. Each positioning pin 31 has one axial end, which is press-fitted in a first recess part 32 formed on an axial end surface of the first housing 10 at a side of the first injection hole 12, and the other axial end, which is press-fitted in a second recess part 33 formed on the large-diameter part 28 of the second housing 20. The positioning pins 31 thus prevent the first housing 10 and the second housing 20 from relatively rotating in the circumferential direction. As a result, the positions of the plural first injection holes 12 provided in the first housing 10 and the positions of the plural second injection holes 22 provided in the second housing 20 are fixed. According to the second embodiment, the first housing 10 and the second housing 20 can be positioned accurately in the circumferential direction.

### Third Embodiment

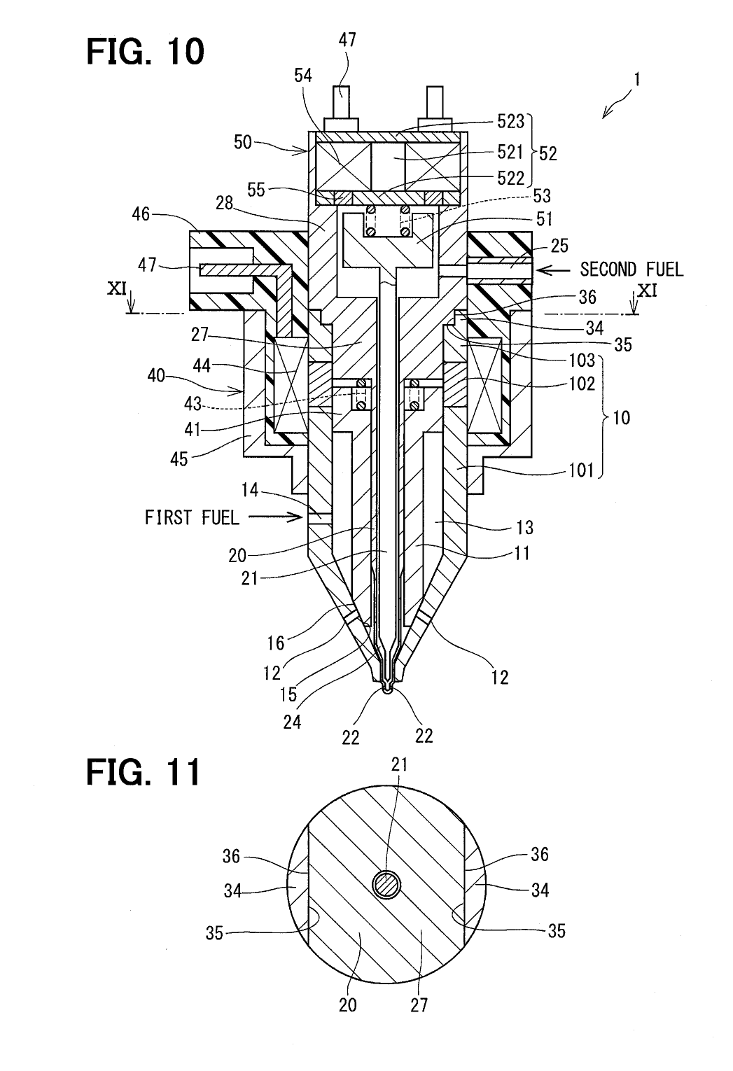

A third embodiment of a fuel injection device is shown in FIG. 10 and FIG. 11. In the third embodiment, the first housing 10 has a pair of protrusions 34, which extends toward a side opposite to the first injection hole 12, on an end surface, which is on a side opposite to the first injection hole 12. Inner walls on radially inner sides of the protrusions 34 are formed to be in parallel to the axis of the first housing 10. The inner walls of the protrusions 34, which are radially inside, are first press-fit surfaces 35.

The second housing 20 has a pair of second press-fit surfaces 36, which is formed on a radially outside wall of the first fixed core part 27 in parallel with the axis of the first housing 10. The second press-fit surfaces 36 are press fit with the first press-fit surfaces 35 of the first housing 10. By press-fitting of the first press-fit surfaces 35 of the first housing 10 and the second press-fit surfaces 36 of the second housing 20, the first housing 10 and the second housing 20 are prevented from relatively rotating in the circumferential direction. In the third embodiment, the first press-fit surface 35 and the second press-fit surface 36 correspond to one example of the fixation part.

According to the third embodiment, it is possible to fit the first housing 10 and the second housing 20 in position in the circumferential direction accurately with a small number of component parts. The first press-fit surface 35 and the second press-fit surface 36 are not limited to be a flat surface, which is parallel to the axis of the first housing 10, but may be non-circular surfaces such as polygonal or elliptic, which are capable of being press-fitting.

Here, advantage of contacting of fuel sprays will be discussed with reference to two reference examples 1 and 2, in which the fuel sprays are contacted and not contacted, respectively.

### Reference Example 1

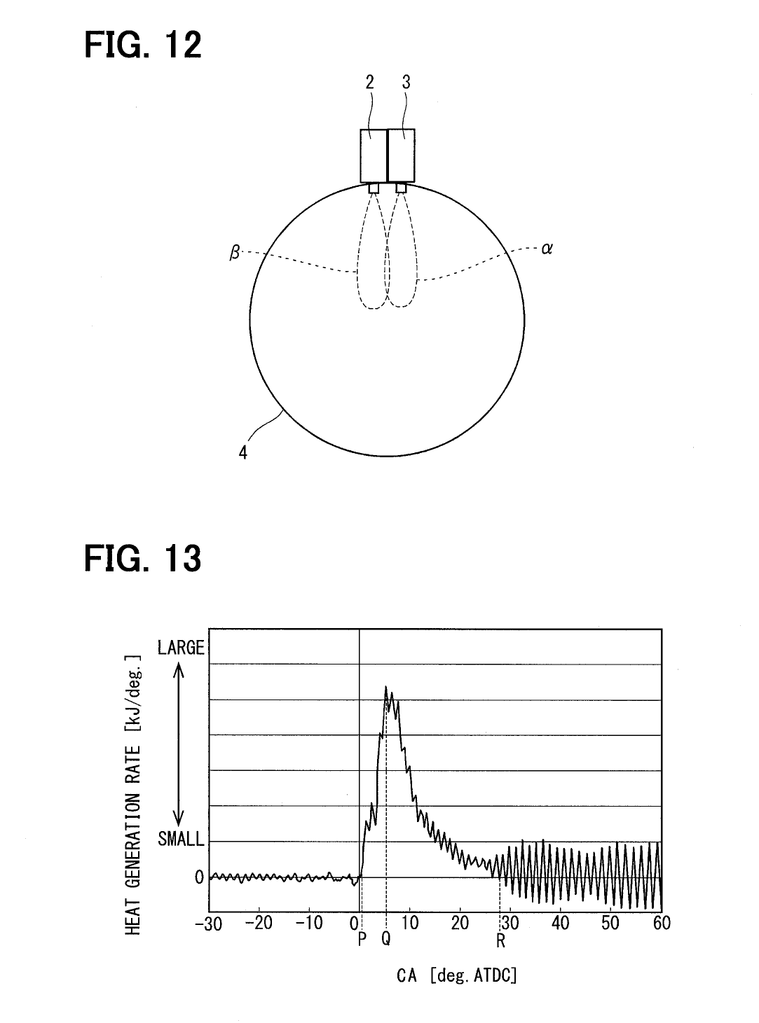

A reference example 1 is shown in FIG. 12 and FIG. 13. FIG. 12 shows that two fuel injection devices 2 and 3 are mounted on a cylinder 4 of an internal combustion engine. FIG. 12 illustrates a state that the fuel spray β of light oil injected from the fuel injection device 2 and the fuel spray a of natural gas injected from the fuel injection device 3 contact each other.

FIG. 13 shows a heat generation rate under a state illustrated in FIG. 12. FIG. 13 shows that the fuel spray of light oil ignited at a crank angle P degrees and a flame of the light oil ignited the fuel spray of natural gas for combustion. The heat generation rate became a maximum at a crank angle Q degrees and the combustion ended near a crank angle R degrees.

### Reference Example 2

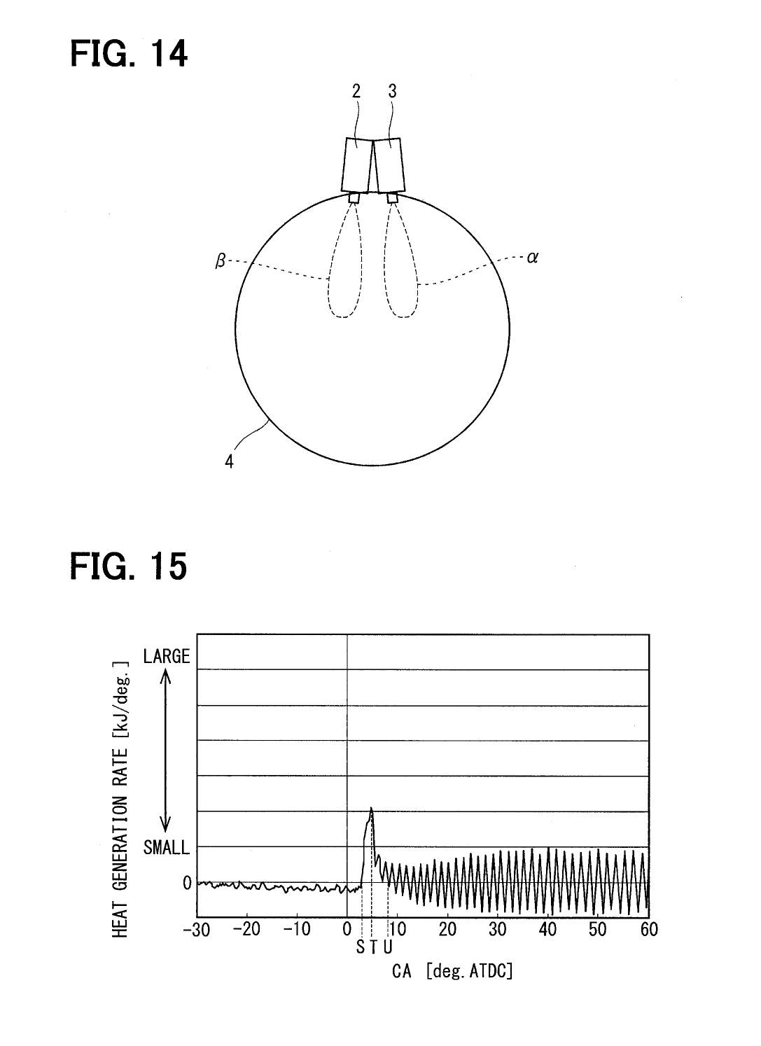

A reference example 2 is shown in FIG. 14 and FIG. 15. Of two fuel injection devices 2 and 3 in the reference example 2, one fuel injection device 2 is provided for injecting only light oil and the other fuel injection device 3 is provided for injecting only natural gas. FIG. 14 illustrates a state that the fuel spray β of light oil injected from the fuel injection device 2 and the fuel spray a of natural gas injected from the fuel injection device 3 do not contact each other.

FIG. 15 shows a heat generation rate under a state illustrated in FIG. 14. FIG. 15 shows that the fuel spray of light oil ignited and combustion of fuel started at a crank angle S degrees. The heat generation rate became a maximum at a crank angle T degrees and the combustion ended near a crank angle U degrees. The quantity of combustion of fuel shown in a graph of FIG. 15 is considered to be smaller than that shown in the graph of FIG. 13. This is considered to arise, because the fuel spray of light oil and the fuel spray of natural gas do not contact each other in the state shown in FIG. 14. As a result, even when the light oil burns by self-ignition, the flame of light oil cannot ignite the fuel spray of natural gas for combustion. The experimental results of the reference examples 1 and 2 described above indicate that, it is essential to contact the fuel sprays of light oil and natural gas in a case of using light oil and natural gas as fuel.

### Other Embodiment

(1) In the embodiments described above, the light oil and the natural gas are exemplarily used as fuels of high cetane number and low cetane number, respectively. However, as the other embodiment, GTL (gas to liquids) and the like may be used as the fuel of high cetane number as far as it is self-ignitable when air is compressed in the cylinder of the internal combustion engine. Methanol, ethanol, LPG and the like may be used as the fuel of low cetane number as far as it is combustible when ignited by a flame generated by the self-ignition of the fuel of high cetane number. The fuel, which the fuel injection device 1 injects, may be liquid fuel or gaseous fuel.

(2) In the embodiments described above, the fuel of low cetane number is referred to as the first fuel and the fuel of high cetane number is referred to as the second fuel. Alternatively, as the other embodiment, the fuel of high cetane number may be referred to as the first fuel and the fuel of low cetane number may be referred to as the second fuel. For example, the fuel injection device 1 may be configured to inject light oil from the first injection hole 12 and inject natural gas from the second injection hole 22.

(3) In the embodiments described above, the fuel injection device 1 is configured such that the driving parts 40 and 50 electromagnetically drive the first needle valve 11 and the second needle valve 21, respectively. Alternatively, as the other embodiment, each driving part may be a piezo-electric actuator, a hydraulic actuator or the like.

(4) In the embodiments described above, the fuel injection device 1 is configured to inject fuels from the plural first injection holes 12 and from the plural second injection holes 22 simultaneously. Alternatively, as the other embodiment, the fuel of high cetane number may be injected first followed by injection of the fuel of low cetane number. That is, by injecting the fuel of low cetane number when the fuel of high cetane number injected first ignites itself, the fuel spray of low cetane number is restricted from mixing with air and rarefying.

The fuel injection device described above is not limited to the above-described embodiments but may be implemented as a combination of the plural embodiments and in different configuration.

What is claimed is:

1. A fuel injection device comprising:
a first housing including a first injection hole for injecting first fuel, a first fuel passage communicated with the first injection hole and a first valve seat formed on an inner wall of the first fuel passage;
a first needle valve housed inside the first housing to be reciprocally movable in an axial direction of the first housing for opening and closing the first injection hole by separating from and seating on the first valve seat;
a second housing including a second injection hole for injecting second fuel of a cetane number different from that of the first fuel, a second fuel passage communicated with the second injection hole, and a second valve seat formed in the second fuel passage;
a second needle valve housed inside the second housing to be reciprocally movable in an axial direction of the second housing for opening and closing the second injection hole by separating from and seating on the second valve seat; and
a fixation part for fixing positions of the first injection hole and the second injection hole such that a spray of the first fuel injected from the first injection hole and a spray of the second fuel injected from the second injection hole contact each other.

2. The fuel injection device according to claim 1, wherein:
the fuel of high cetane number between the first fuel and the second fuel is self-ignitable through compression of air in a cylinder of an internal combustion engine; and
the fuel of low cetane number is combustible through ignition caused by a flame of self-ignition of the fuel of high cetane number.

3. The fuel injection device according to claim 1, wherein:
the second housing is provided radially inside the first needle valve, which is formed in a cylindrical shape; and
the fixation part restricts the first housing and the second housing from rotating relatively in a circumferential direction of the first housing and the second housing.

4. The fuel injection device according to claim 1, wherein:
the first housing has the first injection hole at plural positions to provide plural first injection holes;
the second housing has the second injection hole at plural positions to provide plural second injection holes;
all sprays of the fuel of low cetane number between the first fuel and the second fuel are contactable to sprays of the fuel of high cetane number.

5. The fuel injection device according to claim 4, wherein:
a number of the plural first injection holes and a number of the plural second injection holes are equal.

6. The fuel injection device according to claim 1, wherein:
the first injection hole and the second injection hole are arranged with a spacing in the axial direction of the first housing and the second housing and provided at same angular positions in a circumferential direction of the first housing and the second housing.

7. The fuel injection device according to claim 1, wherein:
a central axis of the first injection hole and a central axis of the second injection hole are arranged to be parallel to each other or separate more in proportion to distances from the first injection hole and the second injection hole.

8. The fuel injection device according to claim 1, wherein:
a central axis of the first injection hole and a central axis of the second injection hole are arranged to be parallel to each other, or arranged to approach more in proportion to distances from the first injection hole and the second injection hole such that a quantity of exhaust emission is maintained at a generally same level as a case that the central axis of the first injection hole and the central axis of the second injection hole are arranged to be separated more in proportion to the distances from the first injection hole and the second injection hole.

9. The fuel injection device according to claim 1, wherein:
a central axis of the first injection hole and a central axis of the second injection hole cross each other with an angle between −9° to 19°, assuming that the angle is 0°, a positive value and a negative value, when the central axis of the first injection hole and the central axis of the second injection hole are arranged to be parallel, separate more and approach more in proportion to distances from the first injection hole and the second injection hole, respectively.

10. The fuel injection device according to claim 1, wherein:
the fixation part is a weld part, which fixes the first housing and the second housing at a side more opposite to the first injection hole than the first needle valve is.

11. The fuel injection device according to claim 1, wherein:
the fixation part is a positioning pin, one end of which is press-fitted in a first recess part provided in the first housing and an other end of which is press-fitted in a second recess part provided in the second housing.

12. The fuel injection device according to claim 1, wherein:
the fixation part is a non-circular first press-fit surface formed on a radially inside wall of the first housing and a second press-fit surface formed on a radially outside wall of the second housing and being capable of press-fitting with the first press-fit surface.

13. The fuel injection device according to claim 2, wherein:
the fuel of high cetane number between the first fuel and the second fuel is self-ignitable through compression of air in a cylinder of an internal combustion engine;
the fuel of low cetane number is combustible through ignition caused by a flame of self-ignition of the fuel of high cetane number;
the second housing is provided radially inside the first needle valve, which is formed in a cylindrical shape;
the fixation part restricts the first housing and the second housing from rotating relatively in a circumferential direction of the first housing and the second housing;
the first housing has the first injection hole at plural positions to provide plural first injection holes;
the second housing has the second injection hole at plural positions to provide plural second injection holes;
a number of the plural first injection holes and a number of the plural second injection holes are equal;
the first injection holes and the second injection holes are arranged with a spacing in the axial direction of the first housing and the second housing and provided at same angular positions in a circumferential direction of the first housing and the second housing;
a central axis of the first injection hole and a central axis of the second injection hole are arranged to cross each other with an angle between −9° to 19°, assuming that the angle is 0°, a positive value and a negative value, when the central axis of the first injection hole and the central axis of the second injection hole are arranged to be parallel, separate more and approach more in proportion to distances from the first injection hole and the second injection hole, respectively; and
the fixation part is positioned at a side more opposite to the first injection hole than the first needle valve is.
